(19) United States
(12) Patent Application Publication
(10) Pub. No.: US 2006/0076348 A1
(43) Pub. Date: Apr. 13, 2006

(54) Electrical outlet box having attachable walls

(75) Inventor: Alain Michaud, St-Jean-sur-Richelieu (CA)

Correspondence Address: HOFFMAN & BARON, LLP, 6900 JERICHO TURNPIKE, SYOSSET, NY, 11791, US

(73) Assignee: Thomas & Betts International, Inc.

(21) Appl. No.: 11/235,917

(22) Filed: Sep. 27, 2005

Related U.S. Application Data
(60) Provisional application No. 60/617,895, filed on Oct. 12, 2004.

(51) Int. Cl. H02G 3/08

(52) U.S. Cl. 220/3.94

(57) ABSTRACT

An electrical outlet box including a first planar box wall and a second planar box wall. The first and second box walls are positioned substantially perpendicular to each other. One of the walls includes an extending clip. The other wall includes a receiving slot. The clip is insertable into the slot to couple the first box wall to the second box wall.

### CROSS-REFERENCE TO RELATED APPLICATIONS

This application claims priority to U.S. Provisional Application No. 60/617,895, filed Oct. 12, 2004.

### FIELD OF THE INVENTION

The present invention relates to electrical outlet boxes. More particularly, the present invention relates to metallic electrical outlet boxes having plural walls which are assembled together to form the box.

### BACKGROUND OF THE INVENTION

It is well known to use electrical outlet boxes to house electrical components such as switches and receptacles. The boxes are attached to wall studs. Once the wall board is placed over the studs, the outlet box provides access to the components.

Many electrical outlet boxes are formed of metal. These metallic outlet boxes typically include a back wall, a perimetrical side wall and an open-front face defining a box interior through which a switch or receptacle is placed. The boxes are typically constructed from multiple walls which are assembled together. The most common technique for assembling boxes is to fold a planar sheet of metal into a U-shaped configuration this defines the top, bottom and back walls. Then side walls may be attached to the U-shaped member to form the box. Common techniques to secure the walls of the box together include the use of separate fastening hardware such as a screw which must be accurately fastened to correctly assemble the box. Another technique is to weld the side walls to the U-shaped member to form the box.

While these techniques serve adequately to provide an electrical box which will house a switch or receptacle, boxes formed by these techniques are expensive and time consuming to manufacture.

It can be appreciated that improper weldments may result in an inadequately formed box and use of screws requires a secondary component and the risk of stripping the threads of the screws upon assembly.

It is therefore desirable to provide an electrical box which may be more easily, quickly and reliably assembled.

### SUMMARY OF THE INVENTION

The present invention provides an electrical outlet box including a first planar box wall and a second planar box wall. The first and second box walls are positioned substantially perpendicular to each other. One of the walls includes an extending clip. The other wall includes a receiving slot. The clip is insertable into the slot to couple the first side wall to the second side wall.

The slot may be formed as an aperture in the other side wall or alternatively, the slot may be formed by a portion of the side wall being struck outwardly therefrom. It is also contemplated that the clip can be captively retained in the slot.

### BRIEF DESCRIPTION OF THE DRAWINGS

FIG. 1 is a perspective showing of the electrical box of the present invention including assembly of side walls of the box.

FIG. 2 is a perspective showing of a U-shaped portion of an alternative embodiment of the electrical outlet box of the present invention.

FIG. 3 is an end view of a U-shaped portion of the box of FIG. 2.

FIGS. 4 and 5 show, respectively, side and end views of side walls attachable to the U-shaped portion of the electrical outlet box of FIG. 2.

### DETAILED DESCRIPTION OF THE PREFERRED EMBODIMENTS

The present invention provides an electrical outlet box. More particularly, the present invention provides a metallic electrical outlet box that may be assembled without the need for fastening hardware, such as screws or a secondary operation, such as welding.

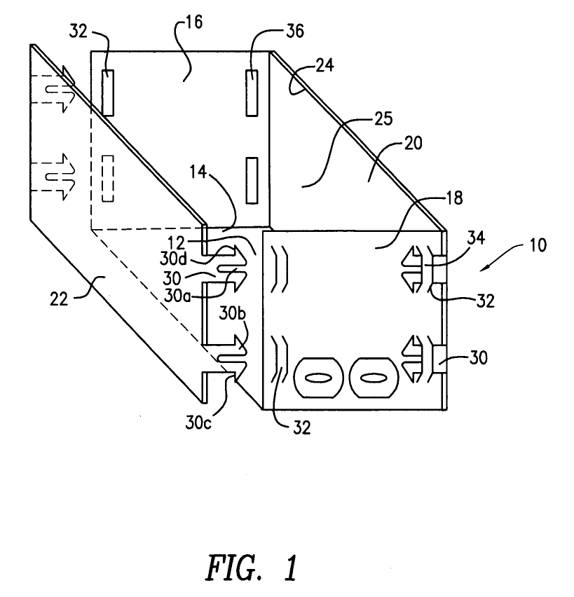

Referring now to FIG. 1, an electrical outlet box 10 in accordance with the present invention is shown. Electrical outlet box 10 is formed from a planar sheet of metal 12 which is arranged in a U-shaped configuration to define a back wall 14 and opposed top and bottom walls 16 and 18. As will be described in further detail hereinbelow, a pair of side walls 20 and 22 are attachable to the U-shaped member 12 to form an enclosed box having an open front face 24 which defines a box interior 25. As is well known, a switch, receptacle (not shown) or the like may be inserted through the open front face 24 into the interior 25 of the box where electrical wires (not shown) may be brought to terminate the switch or receptacle.

Traditionally, electrical outlet boxes are formed by attaching the side walls 20 and 22 to the U-shaped member 12 with the use of mechanical fasteners such as screws or by welding the side walls to the U-shaped member. The present invention provides a simple and secure technique for attaching side walls 20 and 22 to U-shaped member 12 without the need for secondary operations such as weldments or additional mechanical fasteners.

In the embodiment shown in FIG. 1, side walls 20 and 22 each include, at the ends thereof, clips 30. Each of clips 30 extends generally perpendicular from opposed ends of the sidewalls. Moreover, the end walls 16 and 18 include along a periphery thereof slots 32. In the present illustrative embodiment, slots 32 are formed by striking out from the surface of the end walls, a web 34 of material which forms a protruding strap. As the web 34 is struck from the planar walls, an opening 36 is formed thereunder.

Clips 30 are generally dual-tine shaped members having a U-shaped trough 30a between spaced apart tines 30c and 30b. The tines may include hooked ends 30d. The trough 30a allows some degree of flexibility for the tines so that the tines may fit within the slot formed by the extending web 34. Hooked ends 30d engage the web 34 to secure the clip in the slot. Thus, upon attachment of the side walls 20 and 22 to end walls 16 and 18 the relationship between the extending clips 30 and slots 32 secures the side walls to the U-shaped member 12. This is done without need for separate mechanical fasteners or welding. The slight flexibility provided by the U-shaped trough 30a, allows insertion of the clips into the slots and the hooks 30b securely retain the clips in the slots preventing removal therefrom.

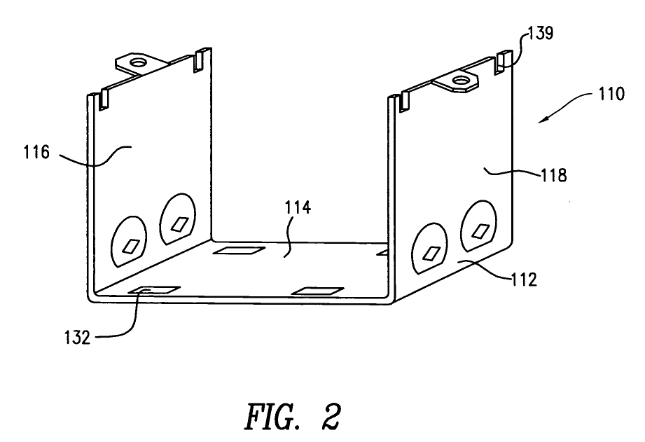

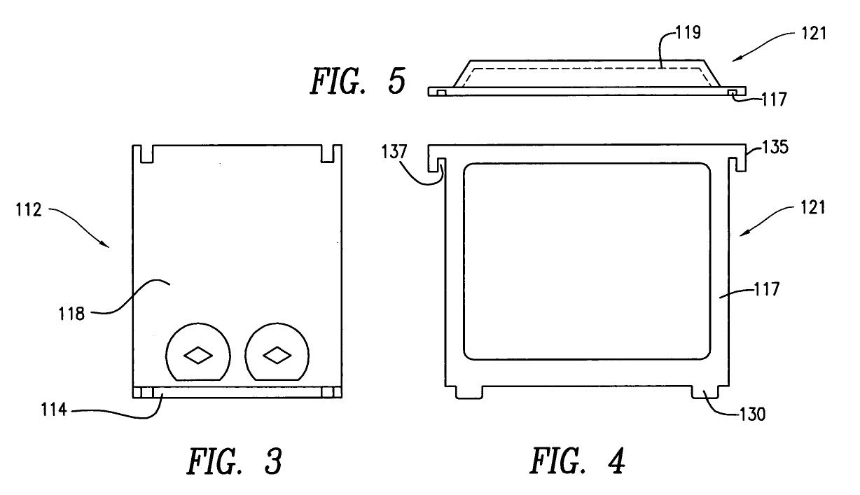

Referring to FIGS. 2-5, an alternative embodiment of the present invention is shown. Box 110 includes a U-shaped member 112 formed of a sheet of metal so as to define a back wall 114 and top and bottom walls 116 and 118. The side walls are attached to U-shaped member 112 to form the enclosed box 110 having an open front face 124. One of the side walls shown in FIGS. 4 and 5, is generally planar member 117 having an outward central bulge or raised area 119 to increase the interior volume of the box. Side wall 121 includes a pair of depending clips 130 which are planar in fashion and which extend from one peripheral side thereof. Clips 130 are insertable into slots 132 in the back wall 114 of U-shaped member 112. The opposed peripheral side of side wall 121 includes a pair of laterally extending hooks 135. The hooks 135 define recesses 137 between the side wall and the end of the hook. The top and bottom walls 116 and 118 are formed to have a pair of mating recesses 139 at the upper edge thereof. The recesses 137 of hook 135 are fittablly assembled in the mating recesses 139 of the top and bottom walls 116 and 118 to captively retain the side wall 121 in position upon attachment. When so positioned, the clips 130, which are bendable, may be bent against the back wall 114 to securely and permanently attach the side walls 121 to U-shaped member 112.

As can be appreciated, the present invention therefore, provides the ability to assemble an electrical outlet box having plural separable walls without the need for use of separate mechanical fasteners or a secondary operation such as welding. This greatly reduces the manufacturing cost of the assembled box.

What is claimed is:

1. An electrical outlet box comprising:
a first planar box wall; and
a second planar box wall generally perpendicular to said first box wall;
one of said box walls including an extending clip and the other of said box walls including a receiving slot, said clip being insertable into said slot to couple said first planar box wall to said second planar box wall.

2. An electrical outlet box of claim 1 wherein said slot is formed as an aperture in said other box wall.

3. An electrical outlet box of claim 1 wherein said slot is formed by a portion of said other box wall being struck outwardly therefrom.

4. An electrical outlet box of claim 1 wherein said clip is captively retained in said slot.

5. An electrical outlet box of claim 1 wherein said clip is a bendable member and is bent upon insertion into said slot.

6. An electrical outlet box of claim 5 wherein said one wall includes a hook and said other wall includes a recess said hook being accommodating in said recess to further secure said one wall to said other wall.

7. An electrical outlet box comprising:
a U-shaped member having two opposing end a walls and a back wall therebetween;
a first planar side wall generally perpendicular to said U-shaped member, said first planar side wall attached to said two opposing end walls and extending therebetween;
a second planar side wall generally perpendicular to said U-shaped member and generally parallel to said first planar side wall, said second planar side wall attached to said two opposing end walls and extending therebetween; and
wherein said end walls of said U-shaped member including receiving slots, and said planar side walls include extending clips, said clips being insertable into said slots to couple said U-shaped member to said planar side walls.

8. An electrical outlet box of claim 7 wherein said clips are dual-tine shaped members having a U-shaped trough and spaced apart tines.

9. An electrical outlet box of claim 8 wherein each of said spaced apart tines include a hooked end for retaining said clips in said slots.

10. An electrical outlet box of claim 9 wherein each of said slots include a protruding strap forming an opening between said strap and said end wall.

11. An electrical outlet box comprising:
a U-shaped member having a top wall, a bottom wall and a back wall extending between said top wall and said bottom wall, said top wall and said bottom wall include a pair of mating recesses; and
a pair of opposing side walls extending between said top wall and said bottom wall, said side walls include a pair of laterally extending hooks which engage with said pair of said mating recesses of said top wall and said bottom wall to captively retain said side walls to said top wall and said bottom wall.

12. An electrical outlet box of claim 11 wherein said back wall includes receivable slots and said side walls include extending clips which extend into said receivable slots of said back wall.
